(19) United States
(12) Patent Application Publication
(10) Pub. No.: US 2002/0010698 A1
(43) Pub. Date: Jan. 24, 2002

(54) Method of applying locking function to electronic documents and text messages

(76) Inventors: Dong Wook Shin, Seongnam-Si (KR); Sung Chul Lee, Cheonan-Si (KR)

Correspondence Address: JACOBSON HOLMAN PLLC, 400 SEVENTH STREET N.W., SUITE 600, WASHINGTON, DC, 20004, US

(21) Appl. No.: 09/891,416

(22) Filed: Jun. 27, 2001

(30) Foreign Application Priority Data
Jul. 13, 2000 (KR) 2000-40214

(51) Int. Cl. G06F 17/30; G06F 7/00

(52) U.S. Cl. 707/10

(57) ABSTRACT

Provided is a method of applying locking function to electronic documents and/or text messages transmitted through the network, by which the security of the electronic documents is ensured and the reading conditions thereof are specified. There is also provided an electronic documents and/or text messages, comprising: a ) a locking function selection region storing the information whether locking function is applied to the attached electronic document; b) a locking condition region storing one or more conditions for locking the attached electronic document; c) a locking guide message region storing a guide message presented when the locking condition specified is not satisfied, d) a hierarchy information region storing hierarchy information; and, e) a document region storing the document to be transmitted.

### BACKGROUND OF THE INVENTION

1. Field of the Invention

The present invention relates to a method of applying locking function to an electronic document and/or a text message transmitted through the network, such as an electronic mail (e-mail) or message posted up on the bulletin, by which the security of electronic document and/or text message is ensured and the condition for opening and reading the electronic documents and/or text message is specified.

2. Description of the Related Art

With the development of the WWW (World Wide Web) and the explosive increase of TCP/IP (Transmission Control Protocol over Internet Protocol)—based Internet users, electronic documents such as an electronic mail or posting are widely being used for disseminating information,

FIG. 1A is a schematic diagram of a conventional electronic document transmission system, which includes an originating server 1 having a storage means 4, a destination server 2 having a storage means 5, first through Nth drafters 6a through 6n, first through Mth readers 7a through 7m, and the Internet 3 which connects the originating server 1 and the destination server 2. In other words, if one of the first through Nth drafters 6a through 6n prepares an electronic document to be transmitted to the one or more receivers, the originating server 1 stores the electronic document transmitted from the sender in the storage means 4, and then transmits the same to the destination server 2 to be stored in the storage means 5 of the destination server 2. The first through Mth readers 7a through 7m can read the electronic document from the storage means 4 or 5 of the originating or destination server 1 or 2. The first through Nth drafters 6a through 6n can also read the electronic document.

FIG. 1B is a flow chart of a conventional process of posting a notice on an Internet site, the process consisting essentially of the steps of preparing a document (step 10) and reading the document (step 11). In other words, in step 10, a drafter connects to a predetermined Internet site on which one can post up a message, and prepares and posts up the massage in the form of an electronic document. The server of the Internet site stores the message in its storage means. In step 11, the server of the Internet site allows the posted message to be fetched from the storage means to be read by anyone who connects to the Internet site. The posted message may be directly prepared on the Internet site or may have been prepared before connecting to the Internet site. As thus, the message posted on the Internet site is unrestrictedly open to the public that connects the bulletin board of the Internet site. Alternatively, in the case of a site run under subscription basis, the posted message is open to subscribers. Thus, there is no security means for the drafter to restrictedly allow only those who meet prescribed qualification or conditions to read the posted message.

FIG. 1C is a flowchart showing a conventional process of transmitting e-mail, comprising the steps of preparing an e-mail document (step 12), transmitting the e-mail document (step 13) and reading the e-mail document (step 14). In detail, in step 12, an e-mail sender prepares an e-mail document before or after connecting to the originating server 1 and supplies an e-mail receiver's address to the originating server 1. In step 13, the originating server 1 transmits the prepared e-mail document to the destination server 2 to be stored in the storage means 5 of the destination server 2, and the destination server 2 notifies the arrival of e-mail to the receiver. When the e-mail receiver also uses the same originating server 1, the e-mail document is stored in the storage means 4 of the originating server 1. In step 14, the e-mail receiver can read the e-mail document immediately when the e-mail has arrived. That is to say, once the e-mail is transmitted from the sender, the receiver can read the e-mail without any restriction. Thus, even if the e-mail is erroneously transmitted, the e-mail sender cannot restrict the receiver from reading the e-mail. Also, an e-mail message posted onto the bulletin to inform ones of an event is generally transmitted a very long time before the event occurs. In this case, the receiver may forget when or where the event occurs. That is, the known methods do not provide a method for locking an electronic document.

### SUMMARY OF THE INVENTION

To solve the above problem, it is an object of the present invention to provide a security means by which electronic documents and text messages are restrictedly given only to those who meet predetermined qualification or conditions.

It is another object of the present invention to provide a means for restricting reading an erroneously transmitted electronic document and text message.

To accomplish these and other objects described in the detailed description, there is provided a method of applying locking function to an electronic document over the Internet through a locking management server having a locked document storage means in which a locked document comprised of locking function selection region, a locking condition region, a locking guide message region, a hierarchy information region and an electronic document region, is stored, and a plain document storage means in which a plain electronic document is stored, comprising the steps of (1) preparing an electronic document, and (2) reading the electronic document, wherein the step (1) comprises preparing an electronic document and storing hierarchy information, determining whether locking function is applied to the electronic document or not, enabling a locking condition and a locking guide message to be input if the locking function is selected, storing the electronic document in the locking document storage means if the locking function is selected, if not selected, storing the electronic document in the plain document storage means, and the step (2) comprises determining whether the electronic document to be read by the reader is locked or not, transmitting the electronic document to be read if not locked, enabling to input the locking condition if locked, allowing the reader to read the locked document if the locking condition is satisfied, and displaying the locking guide message if the locking condition is not satisfied.

The method of applying locking function to electronic documents according to the present invention can also be employed in transmission/reception of text messages through mobile phones. In this case, a message preparing step and a message reading step corresponding to an electronic document preparing step and an electronic document reading step, respectively, can be preferably performed in a text message management program loaded on a mobile phone.

### BRIEF DESCRIPTION OF THE DRAWINGS

These and other features and advantages of the present invention will be apparent in light of the following detailed description of an illustrative embodiment thereof, as illustrated in the accompanying drawings, in which:

FIG. 1A is a schematic diagram of a conventional electronic document (e-mail) transmission system;

FIG. 1B is a flowchart of a conventional process of posting up a massage on an Internet site;

FIG. 1C is a flowchart of a conventional process of transmitting an e-mail;

FIG. 2A is a preferred embodiment of an electronic document transmission system with locking function according to the present invention;

FIG. 2B shows a structure of a locked document according to the present invention;

FIG. 3A is a flowchart of a process of applying locking function to an electronic document according to the present invention;

FIG. 3B is a flowchart of a process of transmitting the locked document shown in FIG. 3A to a destination server;

FIG. 3C is a flowchart of a process of reading the locked document shown in FIG. 3A, and

FIG. 4 is a schematic diagram showing a connection between mobile phones and a mobile communication network.

### DESCRIPTION OF THE PREFERRED EMBODIMENT

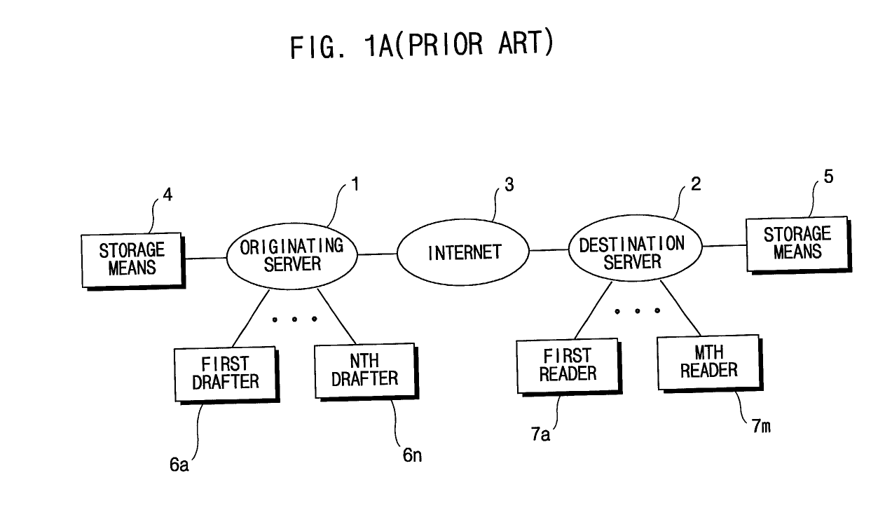

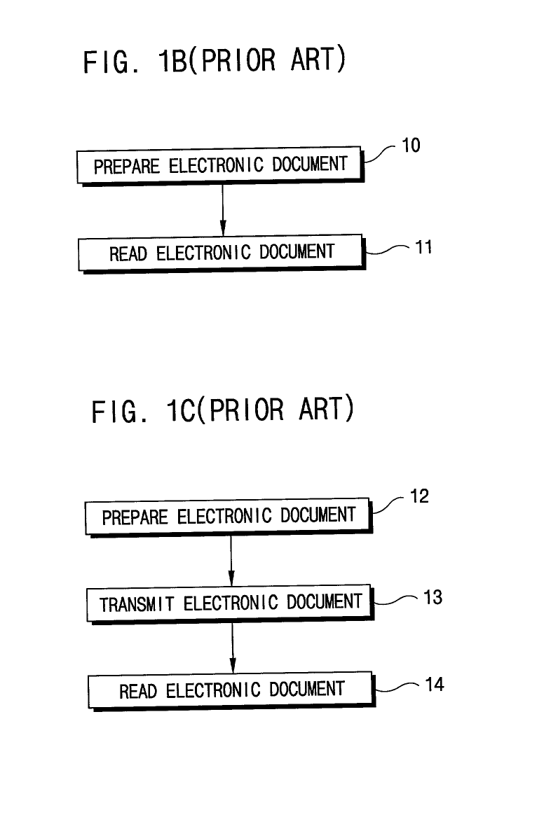

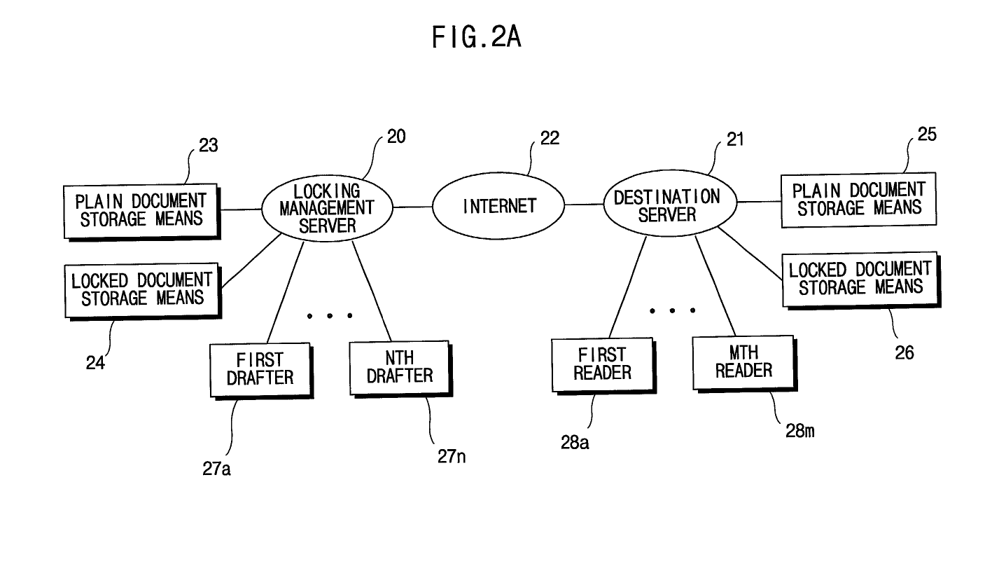

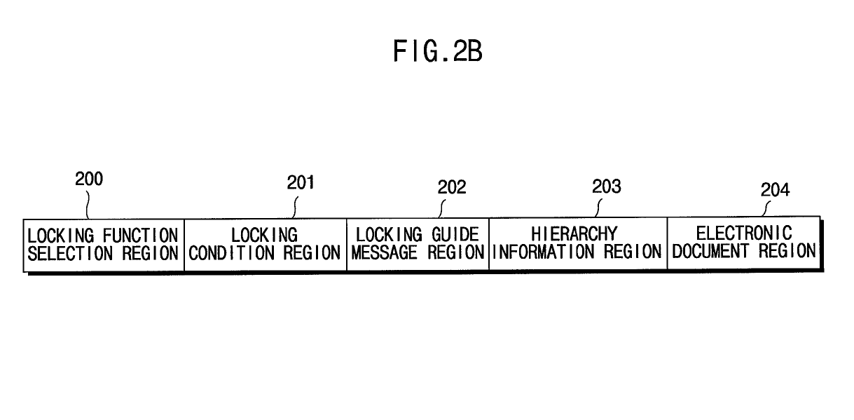

Referring to FIG. 2A showing a preferred embodiment of an electronic document transmission system with locking function according to the present invention, wherein the electronic document transmission system includes a locking function management server 20 and a destination server 21 having plain document storage means 23 and 25, locked document storage means 24 and 26, respectively, first through Nth drafters 27a through 27n that connect to the locking function management server 20, first through Mth readers 28a through 28m that connect to the destination server 21, and the Internet 22 through which the locking function management server 20 and the destination server 21 is connected. In detail, since the first through Nth drafters 27a through 27n may prepare a plain electronic document (which is not locked) or a locked electronic document, the locking function management server 20 that has the capability of applying locking function to an electronic document, includes the plain document storage means 23 and the locked document storage means 24, as described above. Also, if the destination server 21 is the one that has the capability of applying locking function to an electronic document, it may include the plain document storage means 25 and the locked document storage means 26. If not, the destination server 21 may include only a plain electronic document storage means, like the storage means 5 shown in FIG. 1A, in which both the plain document and the locked document can be stored.

FIG. 2B shows a structure of a locked document according to the present invention, including a locking function selection region 200, a locking condition region 201, a locking guide message region 202, a hierarchy information region 203, and an electronic document region 204. The locking function selection region 200 stores the information whether locking function is applied to the attached electronic document. For example, if the locking function selection region 200 is represented by 0, it implies that locking function is not applied to the document. If the locking function selection region 200 is represented by 1, it implies that locking function is applied thereto. Various conditions for locking the attached electronic document can be stored in the locking condition region 201. For example, the date on which the attached electronic document can be open, the specified reader or questions for quiz can be provided. That is to say, if the date on which the attached electronic document can be open is set, e.g., 10:30 am Oct. 5, 2000 (dd-mo-yr), the attached electronic document cannot be open before the date. If the reader is specified, e.g., name, resident number, address, or the school from one graduated, the one other than the specified reader can not open the attached electronic document. If questions for quiz are suggested, a predetermined quiz and the answer thereto, e.g., question “1+1” and answer “2”, are stored in the locking condition region 201. The attached document can only be seen on condition that the correct answer is provided. If more than one locking methods are selected, locking conditions corresponding thereto can be stored successively. The locking guide message region 202 is a region necessary for presenting a guide message to anyone who does not satisfy the locking condition specified by the drafter. For example, if the reading commencement date has not been reached, a guide message saying “please wait.” is presented with the remaining time. If one who is not the specified reader tries to read the electronic document, a guide message saying “You are not the right person.” is presented. If the answer to the quiz is wrong, a guide message saying “Incorrect.” is presented. In the hierarchy information region 203, the name of a drafter (or sender) who has prepared the locked document is stored. That is to say, the name (or ID) of the drafter who has prepared the locked document first is recorded in the hierarchy information region 203. In the case when a reader who has read the locked document makes a reply to the locked document, the name of the reader is added after the drafter's name stored in the hierarchy information region 203. Likewise, names of readers who add more contents to the original document are stored in the hierarchy information region 203.

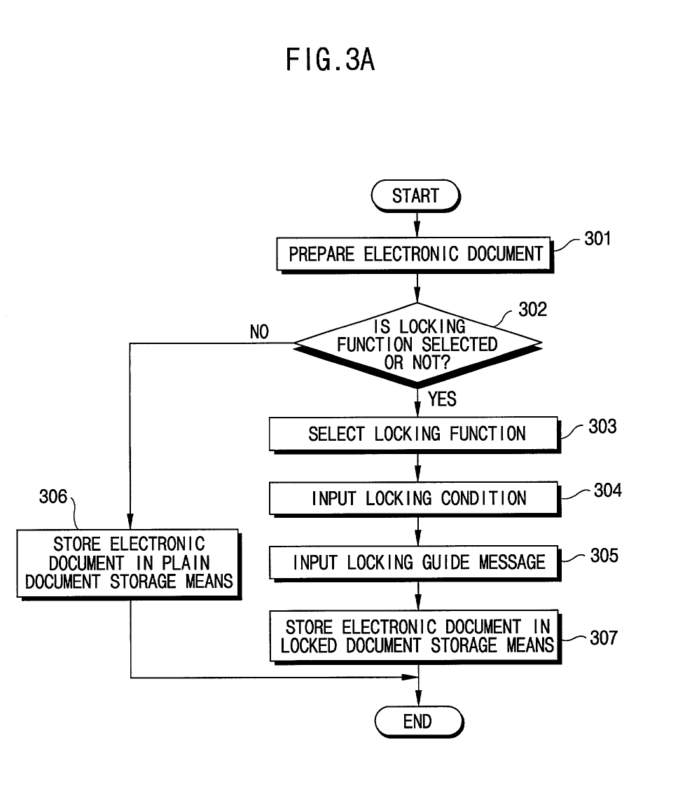

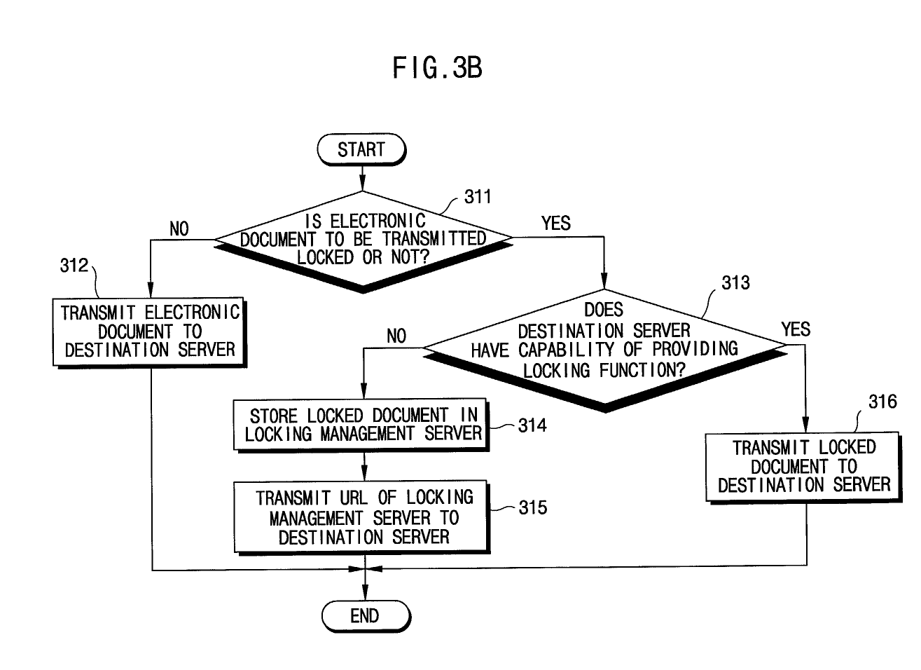

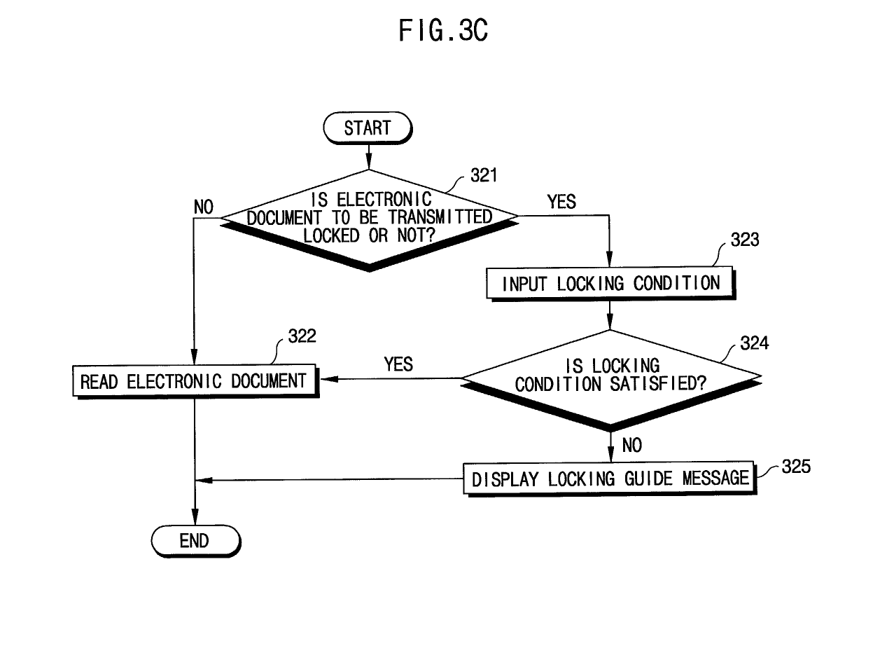

FIG. 3A is a flowchart showing a process for applying locking function to an electronic document according to the present invention, comprising the steps of starting (step 300), preparing an electronic document (step 301), determining whether locking function is selected (step 302), selecting locking function (step 303), inputting a locking condition (step 304), inputting a guide message (step 305), storing an electronic document in a plain document storage means (step 306), and storing an electronic document in locked document storage means (step 307). In detail, in step 300, a drafter who intends to prepare a locked document must be in connection to or must be qualified for connection to the locking management server 20. In step 301, the drafter prepares an electronic document in the same way as conventional. In step 302, locking function provided from the locking management server 20 is selected. In step 303, the drafter selects at least one locking method among those provided from the locking management server 20 based on selection of locking function. In step 304, the locking management server 20 specifies a locking condition corresponding to the selected locking method, so that the drafter writes down the reading commencement date, the identifier of a specified reader or a predetermined quiz. In step 305, the drafter inputs the locking guide message according to applying locking function to the electronic document. In step 307, if locking function is applied to the electronic document, the electronic document is stored in the locked document storage means 24, and in step 306, if locking function is not applied to the electronic document, the electronic document is stored in the plain document storage means 23.

FIG. 3B is a flowchart of a process of transmitting the locked document shown in FIG. 3A to a destination server, the process including the steps of starting (step 310), determining whether a document to be transmitted is a locked document (step 311), determining whether a destination server can provide locking function (step 313), transmitting the document to a destination server (step 312), storing the locked document in a locking management server (step 314), transmitting the URL (Uniform Resource Locator) of the locking management server to the destination server (step 315) and transmitting the locked document to the destination server (step 316). In more detail, in the case where the stored locked document is to be transmitted with an electronic document, the transmission process shown in FIG. 3B is performed. In step 311, the locking management server 20 determines whether the document to be transmitted by the drafter is locked or not. If not locked, the step 312, in which the document is transmitted in the same manner as a plain document is, is performed. If locked, the step 313 is performed. If the destination server 21 can provide locking function, the locking management server 20 transmits the locked document to the destination server 21 (step 316). However, if the destination server 21 cannot provide locking function, even if the locked document is transmitted to the destination server 21, the locked document cannot be opened. Thus, the locking management server 20 keeps the locked document to be stored in the locked document storage means 24 (step 314). Instead, the Internet address of the locking management server 20 is transmitted to the destination server 21 (step 315).

FIG. 3C is a flowchart of a process of reading the locked document shown in FIG. 3A, the process including the steps of determining whether an electronic document is locked or not (step 321), reading the electronic document (step 322), inputting a locking condition (step 323), determining whether the locking condition is satisfied (step 324), and displaying a locking guide message. In more detail, in the case where a reader intends to open an electronic document stored in the locking management server 20, it is determined in step 321 whether the electronic document is a locked document or a plain document. If the electronic document is a plain document, it can be open in step 322. In step 323, if the electronic document is a locked document, the locking function selection region 200 in the structure of a locked document shown in FIG. 2B, is fetched by the locking management server 20 to present the locking condition, the answer to the locking condition is input by the reader or the current date is checked. In step 324, it is determined whether the locking condition is satisfied by the input answer or the current date that is input or checked in step 323 satisfies the locking condition. If the lock condition is satisfied (yes), the process goes to step 322, in which the locked document is displayed to allow the reader to open and read the document.

If the locking condition is not satisfied (no), the message stored in the locking guide message region (202 of FIG. 2B) is shown to the reader. The plain electronic document and the locked electronic document are stored in the plain document storage means 23 and the locked document storage means 24 of the locking management server 20, for example, posting up message on the Internet site or electronic transmission between the Intranet. Also, after step 322 shown in FIG. 3C, that is, when the reader who has read the locked document replies thereto after reading the document, hierarchy information of the locked document may be added. In other words, the reader's name may be added after the drafter's name in the hierarchy information region (203 of FIG. 2B). FIG. 3C shows the reading step in the case where the drafter and the reader share one and the same locking management server. However, in the case where the drafter and the reader use different servers, for example, electronic transmission between different servers, that is, in the case where the step of transmitting the electronic document is further provided, as shown in FIG. 3B, when the reader connects to the destination server (21 of FIG. 2A), the destination server 21 allows the reader to read the transmitted electronic document. In the case where the destination server 21 and the locking management server 20 is the same server, the process shown in FIG. 3C is performed. Here, the plain electronic document and the locked document are stored in the plain document storage means and the locked document storage means, respectively. If the destination server 21 cannot provide locking function, the step of the destination server 21 allowing the reader to connect to the locking management server 20, the destination server 21 having received the Internet address of the locking management server 20 transmitted in step 315 of FIG. 3B, may be further provided, before the reading process shown in FIG. 3C.

The method of applying locking function to electronic documents according to the present invention can be also employed in transmission/reception of text messages through mobile phones, and a preferred embodiment thereof will now be described in detail.

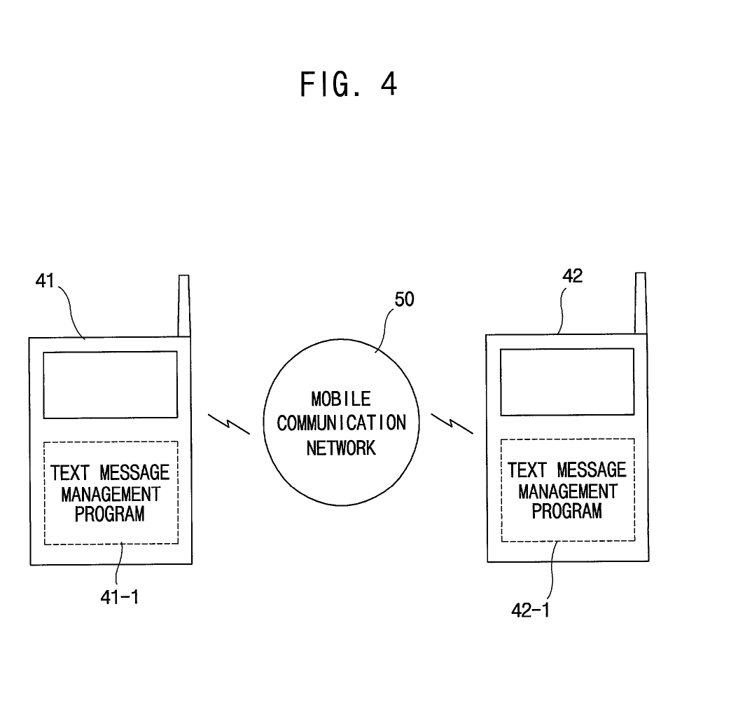

FIG. 4 is a schematic diagram showing a connection between mobile phones and a mobile communication network. Mobile phones 41 and 42 are connected to each other through a mobile communication network 50, to utilize various services such as voice communication, transmission/reception of text messages or video communication. Here, the mobile communication network 50 is a network constructed of components necessary for mobile communication services, including a base transmission station for wireless communication with mobile phones, a base station controller, a mobile switch center, a short message service server and so on. Text message management programs 41-1 and 41-2 are loaded on the respective mobile phones 41 and 42, and perform a message preparation step and a message reading step to be described below.

For the convenience sake of explanation, text message transmission and reception between mobile phones will now be described referring back to the same drawings as described above. Since what are transmitted and/or received through mobile phones are text messages, the term “electronic documents” throughout the description set forth above and the above drawings, is intended to mean “text messages” herein.

A structure of a locked text message transmitted and/or received through the mobile phones 41 and 42 according to the present invention is the same as that of FIG. 2B. That is, the structure of a locked text message includes a locking function selection region 200, a locking condition region 201, a locking guide message region 202, a hierarchy information region 203, and a text message region 204. The locking function selection region 200 stores the information whether locking function is applied to the text message. For example, if the locking function selection region 200 is represented by 0, it implies that locking function is not applied to. If the locking function selection region 200 is represented by 1, it implies that locking function is applied to. Various conditions for locking the text message can be stored in the locking condition region 201. For example, the date on which the text message can be open, the specified reader or questions for quiz can be provided. That is to say, if the date on which the text message can be open is set, e.g., 10:30 am Oct. 5, 2000 (dd-mo-yr), the text message cannot be open before the date. If the reader is specified, e.g., name, resident number, address, or the school from one graduated, the one other than the specified reader can not open the locked text message. If questions for quiz are suggested, a predetermined quiz and the answer thereto, e.g., question “1+1” and answer “2”, are stored in the locking condition region 201. The locked text message can only be seen on condition that the correct answer is provided. If more than one locking methods are selected, locking conditions corresponding thereto can be stored accordingly. The locking guide message region 202 is a region necessary for presenting a guide message to anyone who does not satisfy the locking condition specified by the drafter. For example, if the reading commencement date has not been reached, a guide message saying “please wait.” is presented with the remaining time. If one who is not the specified reader tries to read the text message, a guide message saying “You are not the right person.” is presented. If the answer to the quiz is wrong, a guide message saying “Incorrect.” is presented. In the hierarchy information region 203, the name of a drafter who has prepared the locked text message is stored. That is to say, the name (or ID) of the drafter who has prepared the locked text message first is recorded in the hierarchy information region 203. In the case when a reader who has read the locked text message makes a reply to the locked text message, the name of the reader is added after the drafter's name stored in the hierarchy information region 203. Likewise, names of readers who add more contents to the original document are stored in the hierarchy information region 203. The text message region 204 stores the text message to be transmitted.

Then, a process of applying locking function to a text message according to the present invention will be explained in detail in reference to FIGS. 3A and 3C.

First, referring to FIG. 3A, in step 301, the drafter who intends to transmit a text message prepares the text message in the same way as conventional. In step 302, locking function provided from the text message management program 41-1 and displayed on the screen of the mobile phone 41 is selected. In step 303, the drafter selects at least one locking method among those provided from the text message management program 41-1 based on selection of locking function. In step 304, the text message management program 41-1 specifies a locking condition corresponding to the selected locking method, so that the drafter writes down the reading commencement date, the identifier of a specified reader or a predetermined quiz. In step 305, the drafter inputs the locking guide message according to applying locking function to the text message. In step 307, if locking function is applied to the text message, the text message with information on the selected locking method, a locking condition and locking guide message attached thereto is stored in a predetermined storage area (not shown), and in step 306, if locking function is not applied to the electronic document, the text message is stored in another predetermined storage area (not shown).

The prepared text message is transmitted to a receiver's mobile phone 42 via the mobile communication network 50.

Next, referring to FIG. 3C, a process of reading the locked text message will be explained in detail.

In step 321, the text message management program 42-1 checks whether the text message has the locking function set thereto if the text message received in the receiver's mobile phone 42 is intended to read. If the text message is a plain text message, it can be open in step 322. In step 323, if the text message is a locked text message, the locking function selection region 200 in the structure of a locked text message shown in FIG. 2B, is fetched by the text message management program 42-1 to present the locking condition, the answer to the locking condition is input by the reader or the current date is checked. In step 324, it is determined whether the locking condition is satisfied by the input answer or the current date that is input or checked in step 323 satisfies the locking condition. If the lock condition is satisfied (yes), the process goes to step 322, in which the locked text message stored in the text message region 204 is displayed to allow the reader to open and read the text message. If the locking condition is not satisfied (no), the message stored in the locking guide message region (202 of FIG. 2B) is shown to the reader.

In the above-described embodiment, the text message preparing and reading steps are performed by the text message management program loaded on the mobile phone. However, in the case where a text message is transmitted and/or received by means of wireless internet services, a wireless internet server can act as the text message management program. In other words, the drafter who intends to transmit a locked text message connects to the wireless internet server and prepares a text message according to the content of services provided by the wireless internet server. The wireless internet server transmits the prepared text message to the receiver's mobile phone if the text message received in the receiver's mobile phone is intended to read to cause the text message reading step to be performed. Since the wireless internet server performs the same operation as the locking management server in FIG. 2A, the detailed explanation thereof will be avoided.

As described above, according to the present invention, locking function is applied to an electronic document and/or a text message, thereby maintaining the security of information between the drafter and reader of the electronic document and/or text message. Also, since the security of the electronic document and/or text message can be maintained for a predetermined period of time, another electronic document and/or text message containing different information can be newly transmitted before the lapse of the predetermined period of time. Further, in the event that a drafter erroneously transmits an electronic document and/or text message, that is, when a wrong electronic document and/or text message receiver is specified, since the electronic document and/or text message cannot be opened, only the drafter's intended receiver can read the electronic document and/or text message.

What is claimed is:

1. A method of applying locking function to an electronic document on the Internet through a locking management server having a locked document storage means in which a locked document comprised of locking function selection region, a locking condition region, a locking guide message region, a hierarchy information region and an electronic document region, is stored, and a plain document storage means in which a plain electronic document is stored, comprising the steps of:
(1) preparing an electronic document; and
(2) reading the electronic document, wherein the step (1) comprises:
preparing an electronic document and storing hierarchy information;
determining whether locking function is applied to the electronic document or not;
enabling a locking condition and a locking guide message to be input if the locking function is selected;
storing the electronic document in the locking document storage means if the locking function is selected; and
if not selected, storing the electronic document in the plain document storage means, and the step (2) comprises:
determining whether the electronic document to be read by the reader is locked or not, transmitting the electronic document to be read if not locked, enabling to input the locking condition if locked,
allowing the reader to read the locked document if the locking condition is satisfied; and
displaying the locking guide message if the locking condition is not satisfied.

2. The method according to claim 1, further comprising the step of transmitting the electronic document from the locking management server to one or more destination servers, wherein the transmission is performed by determining whether the electronic document stored is locked or not, if not locked, transmitting the electronic document stored in the plain document storage means to a plain document storage means of the destination server, if locked, determining whether the destination server has a capability of providing locking function or not, if the destination server has a capability of providing locking function, transmitting the locked document from its locked document storage means to a locked document storage means of the destination server, and if the destination server does not have a capability of providing locking function, keeping storing the locked document in its locked document storage means and transmitting the site address of the locking management server to the destination server.

3. The method according to claim 1, wherein the condition for locking an electronic document is selected from the group consisting of the date on which the attached electronic document can be open, the specified reader, questions for quiz and combinations thereof.

4. The method according to claim 2, wherein the condition for locking an electronic document is selected from the group consisting of the date on which the attached electronic document can be open, the specified reader, questions for quiz and combinations thereof.

5. The method according to claim 1, wherein the electronic document is selected from the group consisting of e-mail and message posted up on a bulletin.

6. The method according to claim 5, wherein a reply from a certain reader to the message posted up on a bulletin is posted up in the order of hierarchy information stored in the hierarchy information region.

7. A locked document including an electronic document and a text message transmitted through the network, comprising:
a) a locking function selection region storing the information whether locking function is applied to the attached electronic document;
b) a locking condition region storing one or more conditions for locking the attached electronic document;
c) a locking guide message region storing a guide message presented when the locking condition specified is not satisfied.
d) a hierarchy information region storing hierarchy information; and,
e) a document region storing the document to be transmitted.

8. The locked document according to claim 7, wherein the locked document is selected from the group consisting of e-mail, message posted up on a bulletin and text message transmitted though mobile phone.

9. The locked document according to claim 7, wherein the condition for locking an document is selected from the group consisting of the date on which the attached document can be open, the specified reader, questions for quiz and combinations thereof.

10. A method of applying locking function to a text message transmitted and/or received between mobile phones connected by a mobile communication network, the method comprising the steps of:
a message preparing step of configuring a transmitter's mobile phone of the mobile phones such that a user who intends to transmit the text message selects a desired locking function among one or more locking functions and inputs locking condition information on the selected locking function, and attaching locking function indicating information and the locking condition information to the text message;
a message transmitting step of transmitting the text message prepared in the message preparing step to a receiver's mobile phone via the mobile communication network; and
a message reading step of checking whether the text message has the locking function set thereto if the text message received in the receiver's mobile phone is intended to read, receiving the locking condition information on the locking function or determining locking condition information if the locking function is set to the text message, and displaying the text message on the screen of the receiver's mobile phone only when the locking condition information is identical with that attached to the text message.

11. The method according to claim 10, wherein the message preparing step and the message reading step are performed by a text message management program loaded on the mobile phones.

12. The method according to claim 10, wherein a data region for setting the locking function includes a locking condition region in which the locking condition information on the locking function is stored, a guide message region in which a guide message to be displayed when a trial of reading the text message is not successful, is stored, and a hierarchy information region in which the name of a user who read the text message is stored.

13. The method according to claim 11, wherein the message preparing step includes:
storing drafter's name of the text message in the hierarchy information region;
supplying one ore more text message locking functions to cause the drafter to select the same;
processing the text message as a plain text message if no locking function is selected by the drafter, or storing the locking function indicating information in the locking function selection region if one or more locking functions are selected by the drafter;
processing the locking condition information corresponding to the selected locking functions to be input if one or more locking functions are selected, and storing the input locking condition information in the locking condition region; and
causing a guide message to be displayed when the text message cannot be read due to the locking function set thereto, to be input if the locking functions are selected, and storing the input guide message in the guide message region.

14. The method according to claim 12, wherein the message reading step includes:
checking whether there is a locking selection region attached to the text message to determine whether locking function is set to the text message if there is a trial of reading the text message;
performing a reading step of a plain text message if it is determined that no locking function is set to the text message, or causing the locking condition information on the locking function or determining locking condition information if the locking function is set to the text message;
checking whether the determined locking condition information is identical with that stored in the locking condition region attached to the text message;
processing the text message to be read if the two pieces of locking condition information are identical; and
processing the text message not to be read if the two pieces of locking condition information are not identical with each other, and displaying the guide message stored in the guide message region.

15. The method according to claim 14, wherein, if the text message is normally read and a reply text message is prepared, the message reading step further includes the step of adding identification information of a drafter who has prepared the reply text message, including drafter's name and ID, to the hierarchy information region attached to the text message.

16. The method according to claim 10, wherein the locking function is to specify a reading commencement date of the text message, including year, month, date, minute and second, and the locking condition information is the reading commencement date.

17. The method according to claim 16, wherein the message reading step includes further displaying a remaining time until the reading allowable time limit is reached together with the displayed guide message if the current date determined by the mobile phone itself is not identical with the reading commencement date attached to the text message.

18. The method according to claim 10, wherein the locking function is to specify the identifier of a specified reader who can read the text message, including name, ID and address, and the locking condition information is the reader's identifier.
